(19) United States
(12) Patent Application Publication
(10) Pub. No.: US 2008/0182051 A1
(43) Pub. Date: Jul. 31, 2008

(54) Heat shrinkable retortable packaging article and process for preparing retorted packaged product

(75) Inventors: Brian P. Rivers, Simpsonville, SC (US); Michael E. Broadus, Mauldin, SC (US); Bryan E. Freeman, Enoree, SC (US); Josh E. Johnston, Louisville, KY (US)

Correspondence Address: Rupert B. Hurley Jr.;Sealed Air Corporation, P.O. Box 464, Duncan, SC, 29334, US

(73) Assignee: Cryovac, Inc.

(21) Appl. No.: 11/699,121

(22) Filed: Jan. 29, 2007

(51) Int. Cl. B65B 53/00; B05D 3/02

(52) U.S. Cl. 428/34.9; 427/372.2

(57) ABSTRACT

A retortable packaging article is made from a heat-shrinkable film having at least three layers. The first layer serves as an inside layer of the packaging article, and contains a polyolefin having a melting point of at least 241° F., and/or a polyamide copolymer having a melting point of from 275° F. to 428° F. The first layer of the film is heat sealed to itself. The second layer is an inner film layer containing at least one semi-crystalline polyamide that makes up at least 65 weight percent of the second layer. The third layer serves as an outside layer of the packaging article, and comprises at least one member selected from the group consisting of (i) a polyolefin having a melting point of at least 241° F., and (ii) a polyamide copolymer having a melting point of from 275° F. to 428° F. The film exhibits a total free shrink at 185° F. of at least 20 percent. At least one semi-crystalline polyamide makes up at least 35 volume percent of the multilayer film. A process for preparing a retorted packaged product utilizes the retortable packaging article.

### FIELD OF THE INVENTION

The present invention relates generally to packaging articles, particularly to heat-shrinkable packaging articles suitable for packaging food products which are to undergo retort while remaining inside the package.

### BACKGROUND OF THE INVENTION

Non-shrinkable retortable pouches have been made from various films containing polymers such as polyethylene, polypropylene, polyamide, and polyester. These non-shrinkable pouches have been made using non-shrinkable retortable films. During retorting, the product to be subjected to retort is surrounded by the non-shrinkable retortable film and placed on a retort rack. Such films need to be capable of withstanding retort conditions and provide high flex-crack resistance and vibration-induced abuse-resistance, without sticking to the retort rack and while maintaining seal integrity. However, products packaged in non-shrinkable films generally have excess film around at least a portion of the perimeter of the product. The result is a packaged product that would be improved by a tighter package with less excess film around the product.

Although most heat-shrinkable packaging films are polyethylene-based, heat-shrinkable films containing substantial amounts of polyamide are also known. A typical polyethylene-based heat-shrinkable film is incapable of withstanding the conditions of retort. Retort conditions are typically from 240° F. to 260° F. for a period of from 10 minutes to 3 hours, under high humidity and high pressure. If a typical heat-shrinkable polyethylene-based film is used to package an article and thereafter subjected to retort, the film shrinks during retort and the resulting strain on the heat seals is so great that the heat seals tend to pull apart during retort. Other heat-shrinkable films that are capable of withstanding elevated temperatures, such as cook-in films, tend to lose seal integrity, delaminate, and/or become embrittled by the retort process, i.e., exhibiting flex-cracking after being exposed to retort conditions.

In the last few years, polyamide-based shrink films have begun to compete against polyethylene-based shrink films for the packaging of fresh meat products, even though polyamide is more expensive than polyolefin. One reason is that polyamide-based shrink films can provide higher impact strength per mil than polyethylene-based films. However, polyamide-based shrink films are difficult to produce because it is difficult to carry out the solid-state orientation necessary to impart the desired degree of low-temperature heat-shrinkability to such films. The development of elaborate manufacturing equipment and the use of specific polyamide blends have enabled the production of polyamide-based films having high impact strength and relatively high shrink at relatively low temperature. However, these films are not capable of withstanding retort conditions because they may lose seal integrity, delaminate, and/or become embrittled as they undergo retort conditions. Nevertheless, it would be desirable to provide a heat-shrinkable retortable packaging article containing a relatively high amount of polyamide. For several years, packagers of food products have been desiring a heat-shrinkable packaging article with good performance in retort end use.

### SUMMARY OF THE INVENTION

The present invention is directed to a retortable heat-shrinkable packaging article made from a heat-shrinkable, retortable film that is heat-sealable with seals able to withstand the retort process. The film has external layers containing a relatively high melting point polyolefin and/or polyamide, and an internal layer containing a semi-crystalline polyamide selected from the group consisting of polyamide 6, polyamide 66, and polyamide 6/66. The semi-crystalline polyamide makes up a relatively high percentage of the total film. The seal layers reduce the effect of heat, pressure and moisture on the integrity of the polyamide interior layer(s).

As a first aspect, the invention is directed to a retortable packaging article suitable for packaging a food product to be subject to retort conditions. The packaging article comprises (A) a multilayer heat-shrinkable film having a first outer film layer that serves as an inside layer of the packaging article, as a food contact layer, and as a seal layer, and (B) a second layer that is an inner film layer and that comprises at least one semi-crystalline polyamide selected from the group consisting of polyamide 6, polyamide 66, and polyamide 6/66, with the at least one semi-crystalline polyamide making up at least 65 weight percent of the second layer; and (C) a third layer that is a second outer layer that serves as an outside layer of the packaging article, the third layer comprising at least one member selected from the group consisting of (i) a polyolefin having a melting point of at least 241° F., and (ii) a polyamide homopolymer or polyamide copolymer having a melting point of from 275° F. to 428° F. The first layer comprises at least one member selected from the group consisting of (i) a polyolefin having a melting point of at least 241° F., and (ii) a polyamide homopolymer or polyamide copolymer having a melting point of from 275° F. to 428° F. The multilayer film exhibits a total free shrink at 185° F. of at least 20 percent, measured in accordance with ASTM D-2732. At least one semi-crystalline polyamide selected from the group consisting of polyamide 6, polyamide 66, and polyamide 6/66 makes up at least 35 volume percent of the multilayer film, based on total film volume, and the first layer is heat sealed to itself.

As a second aspect, the invention is directed to a process for preparing a retorted packaged product, comprising: (A) preparing a food product; (B) packaging the food product in a retortable packaging article according to the first aspect of the invention; (C) sealing the article closed so that a packaged food product is made, with the food product being surrounded by the multilayer packaging film; and (D) retorting the food product by subjecting the packaged food product to a temperature of from 212° F. to 300° F. for a period of from 10 minutes to 3 hours.

### BRIEF DESCRIPTION OF THE DRAWINGS

FIG. 1 is a schematic of a two-step process for producing a fully coextruded, heat-shrinkable, retortable film used in the retortable article of the present invention.

FIG. 2A is a schematic of an enlarged upstream portion of the two-step full coextrusion process illustrated in FIG. 1.

FIG. 2B is a schematic of an enlarged downstream portion of the two-step full coextrusion process illustrated in FIG. 1.

FIG. 2C is a schematic of an enlarged alternative upstream portion of the two-step full coextrusion process illustrated in FIG. 2A.

FIG. 3 is a cross-sectional view of an air ring assembly for use in the process of making a retortable film suitable for use in the retortable article of the present invention.

FIG. 4 is a schematic of a one-step process for producing a fully coextruded, heat-shrinkable, retortable film suitable for use in the retortable article of the present invention.

FIG. 5 is a schematic of a two-step process for producing an extrusion-coated, heat-shrinkable, retortable film suitable for use in the retortable article of the present invention.

FIG. 6 is a schematic of an end-seal heat-shrinkable, retortable bag.

FIG. 7 is a longitudinal cross-sectional view of the end-seal bag of FIG. 6

FIG. 8 is a schematic of a side-seal heat-shrinkable, retortable bag.

FIG. 9 is a transverse cross-sectional view of the side-seal bag of FIG. 8.

### DETAILED DESCRIPTION OF THE INVENTION

As used herein, the term “film” is inclusive of plastic web, regardless of whether it is film or sheet. The film can have a thickness of 0.25 mm or less, or a thickness of from 0.5 to 30 mils, or from 0.5 to 15 mils, or from 1 to 10 mils, or from 1 to 8 mils, or from 1.5 to 7 mils, or from 1.5 to 6 mils, or from 2 to 6 mils, or from 2 to 5 mils, or from 2 to 4 mils, or from 2 to 3.5 mils, or from 2.5 to 3.5 mils, or from 1.5 to 4 mils, or from 0.5 to 1.5 mils, or from 1 to 1.5 mils, or from 0.7 to 1.3 mils, or from 0.8 to 1.2 mils, or from 0.9 to 1.1 mils.

As used herein, the phrase “to retort” refers to subjecting a product packaged in a flexible film, such as a food product packaged in a flexible film, to sterilizing conditions of high temperature (i.e., of from 212° F. to 300° F.) for a period of from 10 minutes to 3 hours or more, in the presence of water, steam, or pressurized steam. Retorting is usually carried out at a temperature of from 240° F. to 260° F. for a period of from 10 minutes to 3 hours, under high humidity, and at elevated pressure.

As used herein the phrase “retortable film” refers to a packaging film that can be formed into a packaging article (such as a bag, pouch, lidstock, etc), with the packaging article being filled with an oxygen-sensitive product, heat sealed, and retorted without delamination of the layers of the film. The retort process is also carried out at elevated pressure. In general, the retort process is carried out with the packaged products being placed in an environment pressurized to from 20 to 100 psi, or in another embodiment, from 30 to 40 psi.

The film is a heat-shrinkable film. The film can be produced by carrying out only monoaxial orientation, or by carrying out biaxial orientation. As used herein, the phrase “heat-shrinkable” is used with reference to films which exhibit a total free shrink (i.e., the sum of the free shrink in both the machine and transverse directions) of at least 10% at 185° F., as measured by ASTM D 2732, which is hereby incorporated, in its entirety, by reference thereto. All films exhibiting a total free shrink of less than 10% at 185° F. are herein designated as being non-heat-shrinkable. The heat-shrinkable film can have a total free shrink at 185° F. of at least 15%, or at least 20%, or at least 30%, or at least 40%, or at least 45%, or at least 50%, or at least 55%, or at least 60%, or at least 65%, or at least 70%, as measured by ASTM D 2732.

As used herein, the phrase “ . . . a distance of from X to Y inches downstream of the annular die . . . ”, and the like, refers to a distance measured from the point at which the extrudate emerges from the die to the downstream point at which the water ring is positioned and/or the stream of quenching liquid first comes into contact with the extrudate emerging from the die.

As used herein, the term “package” refers to packaging materials configured around a product being packaged. The phrase “packaged product,” as used herein, refers to the combination of a product which is surrounded by the package.

As used herein, the phrases “inner layer” and “internal layer” refer to any layer, of a multilayer film, having both of its principal surfaces directly adhered to another layer of the film.

As used herein, the phrase “outer layer” refers to any film layer having less than two of its principal surfaces directly adhered to another layer of the film. A multilayer film has two outer layers, each of which has a principal surface adhered to only one other layer of the multilayer film.

As used herein, the term “barrier”, and the phrase “barrier layer”, as applied to films and/or film layers, are used with reference to the ability of a film or film layer to serve as a barrier to one or more gases. In the packaging art, oxygen (i.e., gaseous O₂) barrier layers have included, for example, hydrolyzed ethylene/vinyl acetate copolymer (designated by the abbreviations “EVOH” and “HEVA”, and also referred to as “ethylene/vinyl alcohol copolymer”), polyvinylidene chloride, amorphous polyamide, polyamide MXD6, polyester, polyacrylonitrile, etc., as known to those of skill in the art. The retortable film may further comprise at least one barrier layer.

The film may optionally have one or more barrier layers comprising a nanocomposite, to enhance the barrier property or other properties of the film. The term “nanocomposite” refers to a mixture that includes a monomer, polymer, oligomer, or copolymer having dispersed therein a plurality of individual platelets obtained from an exfoliated modified clay. A modified clay is a clay that has undergone intercalation, which is the process of forming an intercalate. An intercalant is, for example, an ammonium ion that is absorbed between platelets of the layered material (i.e., the clay particles) and complexed with the Na⁺ cations on the plate surfaces. The intercalate is the platelets having the intercalant therebetween. Polymers suitable for use in the nanocomposites include low density polyethylene, linear low density polyethylene, medium density polyethylene, high density polyethylene, polypropylene, polyamide, polyester, and polyacrylonitrile. Other polymers suitable for use in the nanocomposites include ethylene vinyl alcohol copolymer, ethylene vinyl acetate copolymer, polyvinylidene chloride, aliphatic polyketone, liquid crystalline polymers, epoxy, and polyurethane adhesive. The use of nanocomposites to enhance barrier and/or other properties is disclosed in U.S. Pat. No. 6,447,860, to Mueller et al, which is hereby incorporated, in its entirety, by reference thereto.

As used herein, the phrase “tie layer” refers to any internal layer having the primary purpose of adhering two layers to one another. Tie layers can comprise any polymer having a polar group grafted thereon. Such polymers adhere to both nonpolar polymers such as polyolefin, as well as polar polymers such as polyamide and ethylene/vinyl alcohol copolymer. Tie layers can be made from polymers such as polyolefin, modified polyolefin, ethylene/vinyl acetate copolymer, modified ethylene/vinyl acetate copolymer, and homogeneous ethylene/alpha-olefin copolymer. Typical tie layer polymers include anhydride modified grafted linear low density polyethylene, anhydride grafted low density polyethylene, anhydride grafted polypropylene, anhydride grafted methyl acrylate copolymer, anhydride grafted butyl acrylate copolymer, homogeneous ethylene/alpha-olefin copolymer, and anhydride grafted ethylene/vinyl acetate copolymer.

Once a multilayer film is heat sealed to itself or another member of the package being produced (i.e., is converted into a packaging article, e.g., a bag, pouch, or casing), one outer layer of the film is an inside layer of the packaging article and the other outer layer becomes the outside layer of the packaging article. The inside layer can be referred to as an “inside heat seal/product contact layer”, because this is the film layer that is sealed to itself or another article, and it is the film layer closest to the product, relative to the other layers of the film. The other outer layer can be referred to as the “outside layer” and/or as the “outer abuse layer” or “outer skin layer”, as it is the film layer furthest from the product, relative to the other layers of the multilayer film. Likewise, the “outside surface” of a packaging article (i.e., bag) is the surface away from the product being packaged within the bag.

As used herein, the term “quenching” refers to cooling an annular extrudate to accelerate the freezing of the polymers making up the extrudate. The process quenches by applying a quenching liquid to the annular extrudate within a distance of from 0.1 to 8 inches downstream of the point at which the annular extrudate emerges from the annular die. The liquid can be applied to the exterior surface of the annular extrudate, and/or to the interior surface of the annular extrudate. Liquid applied to the interior surface of the annular extrudate serves to both quench the extrudate and support the annular extrudate against its tendency to collapse inwardly. If liquid is applied only to the exterior surface of the annular extrudate, a means for supporting the annular extrudate must be employed to avoid collapse of the extrudate.

While the quenching liquid is applied to the annular extrudate within a distance of from 0.1 to 8 inches downstream of the point at which the annular extrudate emerges from the annular die, the quenching liquid can be applied to the surface of the annular extrudate within a distance of from 0.5 to 6 inches downstream of the annular die, or from 1 to 3 inches. While at least 50% of the applied quenching liquid cascades down the annular extrudate for a distance of at least 2 inches, at least 90% can cascade for a distance of at least 5 inches, or substantially 100 percent of the liquid can cascade for at least 24 inches.

As used herein, the phrase “water ring” refers to a ring-shaped device for delivering a stream of liquid (preferably water) onto the exterior surface of an annular extrudate. The ring itself is hollow, i.e., has a cavity therein. The water ring is supplied with a quenching fluid (preferably water) that passes into the cavity within the ring and then out through a slot in the inside surface of the ring, with the annular stream of water flowing out of the ring and onto the exterior surface of the annular extrudate, for the purpose of quenching the extrudate. The gap in the water ring, from which the water flow is emitted, can be within the range of from 0.02 to 0.5 inch, or 0.03 to 0.3 inch, or 0.05 inch to 0.25 inch, or from 0.07 inch to 0.16 inch. The water ring can emit quenching water at a temperature of from 0° C. to 25° C., or from 5° C. to 16° C.

As used herein, the phrase “air shoe” refers to a device to be positioned inside an annular extrudate to support the extrudate as it emerges immediately after it emerges from the annular die, i.e., before the annular extrudate is quenched. The air shoe can have any desired length, or a length of from 4 to 50 inches, or 6 to 20 inches, and can have any desired diameter, or a diameter of from about 1 to 50 inches, or from 2 to 25 inches, or from 4 to 12 inches. The air shoe can have a round cross-section and can has an interior chamber supplied with pressurized air, with the pressurized air passing from the chamber through a plurality of small air passageway holes through the chamber wall. The air passageway holes can have any desired diameter, or a diameter of from about 0.01 inch to about 0.25 inch, or from 0.02 inch to about 0.1 inch. The air passageway holes can be spaced at uniform intervals over the surface of the air shoe. Each interior hole in the matrix of air passageway holes can have the same number of holes equidistant therefrom, such as 3 holes, four holes, 5 holes, 6 holes, 7 holes, 8 holes, or 9 holes. The equidistant spacings can be any desired distance, or can be from 2 to 40 millimeters, or from 4 to 20 millimeters, or from 10 to 20 millimeters. The air shoe can be supplied with air under a pressure of from 1 to 100 psi, or from 10 to 80 psi. The air shoe can emit air at any desired temperature, or the air shoe can emit air at a temperature of from −10° C. to 25° C., or from 0° C. to 25° C., or from 5° C. to 10° C.

Generally the air shoe has an outside diameter which is relatively close to the diameter of the extrudate, so that the air emitted from the air passageway holes in the air shoe provides an air cushion supporting the annular extrudate. The ration of the inside diameter of the annular die gap (from which the annular extrudate emerges), to the outside diameter of the air shoe, can be from 1:1.1 to about 1:0.5, or from about 1:1 to about 1:0.8, or from 1:1 to 0.85; or from 1:0.99 to 1:0.90, or from 1:0.98 to 1:0.92.

As used herein, the term “adhered” is inclusive of films which are directly adhered to one another using a heat seal or other means, as well as films which are adhered to one another using an adhesive which is between the two films. This term is also inclusive of layers of a multilayer film, which layers are of course adhered to one another without an adhesive therebetween. The various layers of a multilayer film can be “directly adhered” to one another (i.e., one or more layers therebetween) or “indirectly adhered” to one another (i.e., no layers therebetween).

As used herein, the phrases “seal layer,” “sealing layer,” “heat seal layer,” and “sealant layer,” refer to an outer film layer, or layers, involved in heat sealing the film to itself, another film layer of the same or another film, and/or another article which is not a film. Heat sealing can be performed in any one or more of a wide variety of manners, such as melt-bead sealing, thermal sealing, impulse sealing, ultrasonic sealing, hot air sealing, hot wire sealing, infrared radiation sealing, ultraviolet radiation sealing, electron beam sealing, etc.). A heat seal is usually a relatively narrow seal (e.g., 0.02 inch to 1 inch wide) across a film. One particular heat sealing means is a heat seal made using an impulse sealer, which uses a combination of heat and pressure to form the seal, with the heating means providing a brief pulse of heat while pressure is being applied to the film by a seal bar or seal wire, followed by rapid cooling.

In one embodiment, the film does not comprise a crosslinked polymer network. In another embodiment, the film comprises a crosslinked polymer network. Optionally, the film can be irradiated to induce crosslinking of polymer, particularly polyolefin in the film. The relatively high content of polyamide in the film provides a high level of toughness and impact strength, and as a result reduces the need to crosslink any polyolefin that may be present in the film. However, the film can be subjected to irradiation using an energetic radiation treatment, such as corona discharge, plasma, flame, ultraviolet, X-ray, gamma ray, beta ray, and high energy electron treatment, which induce cross-linking between molecules of the irradiated material. The irradiation of polymeric films is disclosed in U.S. Pat. No. 4,064,296, to BORNSTEIN, et. al., which is hereby incorporated in its entirety, by reference thereto. BORNSTEIN, et. al. discloses the use of ionizing radiation for crosslinking polymer present in the film.

Radiation dosages are referred to herein in terms of the radiation unit “RAD”, with one million RADS, also known as a megarad, being designated as “MR”, or, in terms of the radiation unit kiloGray (kGy), with 10 kiloGray representing 1 MR, as is known to those of skill in the art. A suitable radiation dosage of high energy electrons is in the range of up to about 16 to 166 kGy, more preferably about 30 to 90 kGy, and still more preferably, 30 to 50 kGy. Preferably, irradiation is carried out by an electron accelerator and the dosage level is determined by standard dosimetry processes. Other accelerators such as a van der Graaf or resonating transformer may be used. The radiation is not limited to electrons from an accelerator since any ionizing radiation may be used.

The term “polymer”, as used herein, is inclusive of homopolymer, copolymer, terpolymer, etc. “Copolymer” includes copolymer, terpolymer, etc.

As used herein, the phrase “heterogeneous polymer” refers to polymerization reaction products of relatively wide variation in molecular weight and relatively wide variation in composition distribution, i.e., typical polymers prepared, for example, using conventional Ziegler-Natta catalysts. Heterogeneous copolymers typically contain a relatively wide variety of chain lengths and comonomer percentages. Heterogeneous copolymers have a molecular weight distribution (Mw/Mn) of greater than 3.0.

In order to withstand the conditions of retort, the outer layer of the packaging article, and the seal layer of the packaging article, should comprise a polymer having a melting point of at least 241° F. Medium density polyethylene is useful in the outside layer of the packaging article, as well as in the inside layer of the packaging article. Similarly, a polyamide copolymer having a melting point of from 241° F. to 428° F. is also useful in the outside layer of the packaging article, as well as in the inside layer of the retortable packaging article.

As used herein, terms such as “polyamide”, “polyolefin”, “polyester”, etc are inclusive of homopolymers of the genus, copolymers of the genus, terpolymers of the genus, etc, as well as graft polymers of the genus and substituted polymers of the genus (e.g., polymers of the genus having substituent groups thereon).

As used herein, the phrase “homogeneous polymer” refers to polymerization reaction products of relatively narrow molecular weight distribution and relatively narrow composition distribution. Homogeneous polymers are useful in various layers of the multilayer, retortable, heat-shrinkable film. Homogeneous polymers are structurally different from heterogeneous polymers, in that homogeneous polymers exhibit a relatively even sequencing of comonomers within a chain, a mirroring of sequence distribution in all chains, and a similarity of length of all chains, i.e., a narrower molecular weight distribution. Furthermore, homogeneous polymers are typically prepared using metallocene, or other single-site type catalysis, rather than using Ziegler Natta catalysts.

As used herein, the term “polyamide” refers to a polymer having amide linkages, more specifically synthetic polyamides, either aliphatic or aromatic, either in semi-crystalline or amorphous form. It is intended to refer to both polyamides and co-polyamides. The polyamides are preferably selected from nylon compounds approved for use in producing articles intended for use in processing, handling, and packaging food, including homopolymers, copolymers and mixtures of the nylon materials described in 21 C.F.R. 177.1500 et seq., which is incorporated herein by reference. Exemplary of such polyamides include nylon homopolymers and copolymers such as those selected from the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-co-laurallactam)), nylon 6,6/6 (poly(hexamethylene adipamide-co-caprolactam)), nylon 6/66 (poly(caprolactam-co-hexamethylene adipamide)), nylon 66/610 (e.g., manufactured by the condensation of mixtures of nylon 66 salts and nylon 610 salts), nylon 6/69 resins (e.g., manufactured by the condensation of epsilon-caprolactam, hexamethylenediamine and azelaic acid), nylon 11 (polyundecanolactam), nylon 12 (polyauryllactam), nylon MXD6, nylon MXDI, nylon 6I/6T, and copolymers or mixtures thereof.

The semi-crystalline polyamide can be present in the multilayer film in an amount of at least 35 volume percent, based on total film volume. Alternatively, the semi-crystalline polyamide can be present in the multilayer film in an amount of at least 40 volume percent of the film, or at least 45 percent, or at least 50 volume percent, or at least 55 volume percent, or at least 60 volume percent, or at least 65 volume percent, or at least 70 volume percent, or at least 75 volume percent, or at least 80 volume percent, or at least 85 percent, or at least 90 volume percent, or at least 95 volume percent, based on total film volume.

As used herein, the phrase “ . . . the semi-crystalline polyamide comprising at least one member selected from the group consisting of polyamide 6, polyamide 66, polyamide 6/66, with the semi-crystalline polyamide making up at least X volume percent of the annular extrudate, based on total extrudate volume . . . ”, and the like, means that, if only one of the semi-crystalline polyamides is present, it must be present in the film in an amount that makes up at least X volume percent, based on total film volume. If this semi-crystalline polyamide is present in more than one layer of the film, the amount of the semi-crystalline polyamide in the film is the sum of the amounts of the semi-crystalline polyamide in each of the various layers of the film in which that member is present. If more than one of the semi-crystalline polyamides is present in the film, the phrase means that by adding together the respective volume percent(s) of each of the semi-crystalline polyamides present in the film, the resulting sum total of all of the volume percents of the semi-crystalline polyamides must make up at least X volume percent of the film, based on total film volume. In this latter case, no one semi-crystalline polyamide must be present in the film in an amount of at least X volume percent, based on total film volume.

As used herein, a phrase such as “ . . . the semi-crystalline polyamide comprising at least one member selected from the group consisting of polyamide 6, polyamide 66, and polyamide 6/66, wherein the at least one semi-crystalline polyamide makes up at least X weight percent of the layer . . . ”, and the like, means that if only one of the semi-crystalline polyamides is present in a layer, it must be present in the layer in an amount that makes up at least X weight percent of the layer, based on total layer weight. If more than one of the semi-crystalline polyamides is present in the layer, by adding together the respective weight percent of each semi-crystalline polyamide present in the layer, the resulting sum total of all of the weight percents of the semi-crystalline polyamides present in the layer must make up at least X weight percent of the layer, based on total layer weight. In this latter case, no one semi-crystalline polyamide must be present in the layer in an amount of at least X weight percent, based on total layer weight.

The semi-crystalline polyamide in the second layer can be a primary component present in a blend with a secondary component that comprises at least one member selected from the group consisting of polyamide 6/12, 6/69, polyamide 6I/6T, polyamide MXD6, polyamide MXDI, polyamide 66/610, amorphous polyamide (including polyamide 6I/6T), polyether block amide copolymer, polyester (including polyethylene terephthalate/glycol), EVOH, polystyrene, polyolefin (e.g., polybutene, long chain branched homogeneous ethylene/alpha-olefin copolymer, and linear low density polyethylene), and ionomer resin. The secondary component can be present an amount of from about 1 to 40 percent, based on total blend weight. In one embodiment, the secondary component is present in an amount of from 2 to 15 percent, based on a total blend weight. The semi-crystalline polyamide is different from the secondary component. The semi-crystalline polyamide can be present in the second layer in an amount of at least 65 weight percent, based on the weight of the second layer.

As used herein, the term “bag” is inclusive of L-seal bags, side-seal bags, backseamed bags, and pouches. An L-seal bag has an open top, a bottom seal, one side-seal along a first side edge, and a seamless (i.e., folded, unsealed) second side edge. A side-seal bag has an open top, a seamless bottom edge, with each of its two side edges having a seal therealong. Although seals along the side and/or bottom edges can be at the very edge itself, (i.e., seals of a type commonly referred to as “trim seals”), preferably the seals are spaced inward (preferably ¼ to ½ inch, more or less) from the bag side edges, and preferably are made using a impulse-type heat sealing apparatus, which utilizes a bar which is quickly heated and then quickly cooled. A backseamed bag is a bag having an open top, a seal running the length of the bag in which the bag film is either fin-sealed or lap-sealed, two seamless side edges, and a bottom seal along a bottom edge of the bag. A pouch is made from two films sealed together along the bottom and along each side edge, resulting in a U-seal pattern. Several of these various bag types are disclosed in U.S. Pat. No. 6,790,468, to Mize et al, entitled “Patch Bag and Process of Making Same”, the entirety of which is hereby incorporated by reference. In the Mize et al patent, the bag portion of the patch bag does not include the patch. Packages produced using a form-fill-seal process are disclosed in U.S. Pat. No. 4,589,247, herein incorporated, in its entirety, by reference thereto.

While the multilayer heat-shrinkable film can be sealed to itself to form a bag, optionally, a heat-shrinkable patch film can be adhered to the bag. The bag film and/or the patch film can comprise at least one semi-crystalline polyamide selected from the group consisting of polyamide 6, polyamide 66, polyamide 6/66, and polyamide 6/12, with the at least one semi-crystalline polyamide making up at least 50 weight percent of at least one layer of the film, based on total layer weight. The bag film and/or the patch film can have a total free shrink at 185° F. of at least 35 percent as measured using ASTM D-2732. The bag film and/or the patch film can have a total semi-crystalline polyamide content of at least 35 volume percent based on total film volume wherein the semi-crystalline nylon is at least one member selected from the group consisting of polyamide 6, polyamide 66, polyamide 6/66, and polyamide 6/12. In one embodiment, the patch comprises a multilayer heat-shrinkable film in accordance with the first aspect of the present invention.

Casings are also included in the group of heat-shrinkable, retortable packaging articles. Casings include seamless tubing casings which have clipped or sealed ends, as well as backseamed casings. Backseamed casings include lap-sealed backseamed casings (i.e., backseam seal of the inside layer of the casing to the outside layer of the casing, i.e., a seal of one outer film layer to the other outer film layer of the same film), fin-sealed backseamed casings (i.e., a backseam seal of the inside layer of the casing to itself, with the resulting “fin” protruding from the casing), and butt-sealed backseamed casings in which the longitudinal edges of the casing film are abutted against one another, with the outside layer of the casing film being sealed to a backseaming tape. Each of these embodiments is disclosed in U.S. Pat. No. 6,764,729 B2, to Ramesh et al, entitled “Backseamed Casing and Packaged Product Incorporating Same, which is hereby incorporated in its entirety, by reference thereto.

The heat-shrinkable, retortable film can be used as a forming web in a thermoforming device. The film can be heated, for example, by a contact heater, and a vacuum is applied beneath the web causing the web to be pushed by atmospheric pressure down into a preformed mold. In a plug-assist vacuum forming method, after the first or forming web has been heated and sealed across a mold cavity, a plug shape similar to the mold shape impinges on the forming web and, upon the application of vacuum, the forming web transfers to the mold surface. After the forming web is in place, a product is placed, such as by manual loading, on the forming web and a second, substantially non-forming web is disposed over the product. At a sealing station, the packages vacuumize and fusion seal with a sealing device such as a heated jaw. The first or forming web encloses a substantial portion, generally more than half, of the product to be packaged. Thermoforming is used for the packaging of meat products such as bacon. In packaging such products, it is desirable to provide a clear package with good optical properties such as clarity and gloss in order to enhance package appearance for the consumer.

The film can be produced as a fully coextruded film, i.e., all layers of the film emerging from a single die at the same time. Alternatively, the film can be produced using an extrusion coating process in accordance with U.S. Pat. No. 4,278,738, to Brax et al, which is hereby incorporated, in its entirety, by reference thereto.

In the multilayer, heat-shrinkable film, all of the film layers can be arranged symmetrically with respect to the polymeric composition of each film layer. In addition, all of the film layers can be arranged symmetrically with respect to both composition and thickness. In one embodiment, the seal layer is thicker than the second outer layer. The seal layer can have a thickness of from 110% to 300% of the thickness of the second outer layer, or from 150% to 250% of the thickness of the second outer layer.

In one embodiment, the film is annealed. In an alternative embodiment, the film is not annealed. Annealing can be carried out by reheating the film via conduction, convection, or irradiation. For example, annealing can be carried out by passing the film in partial wrap around one or more heated rollers, or by subjecting the film to infrared irradiation. An annular film can be reinflated and annealed while reinflated. One method of annealing is to pass the film in partial wrap around one or more heated rollers. For example, the film to be annealed can be passed in partial wrap around 4 rollers, each having a diameter of from 3-30 inches, with the film being wrapped from about 45 to 225 degrees around each roller, with the rollers being positioned close to one another so that the film travels from 2 to 30 inches between rollers, with each of the annealing rollers providing a metal surface heated to a temperature of from 100° F. to 200° F. In addition, one or more cooling rollers can optionally be provided immediately downstream of the annealing rollers, to cool and stabilize the film.

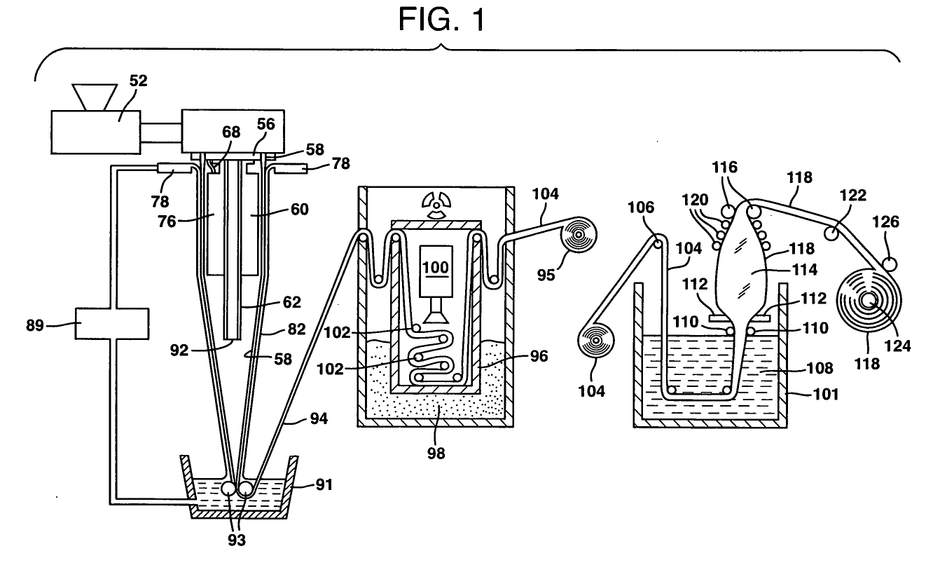

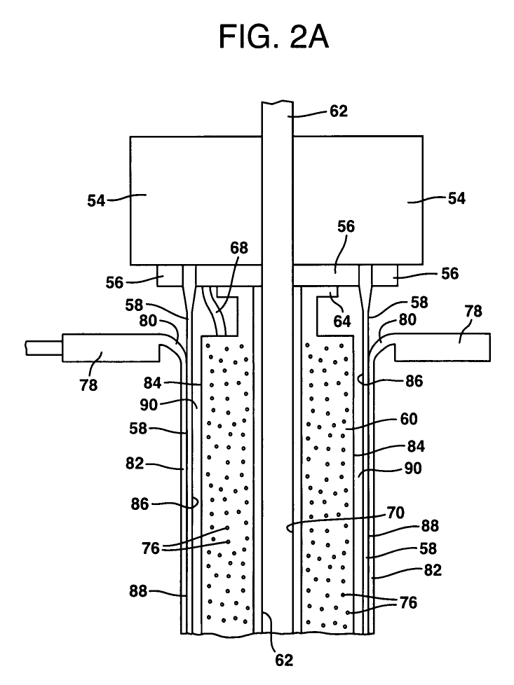

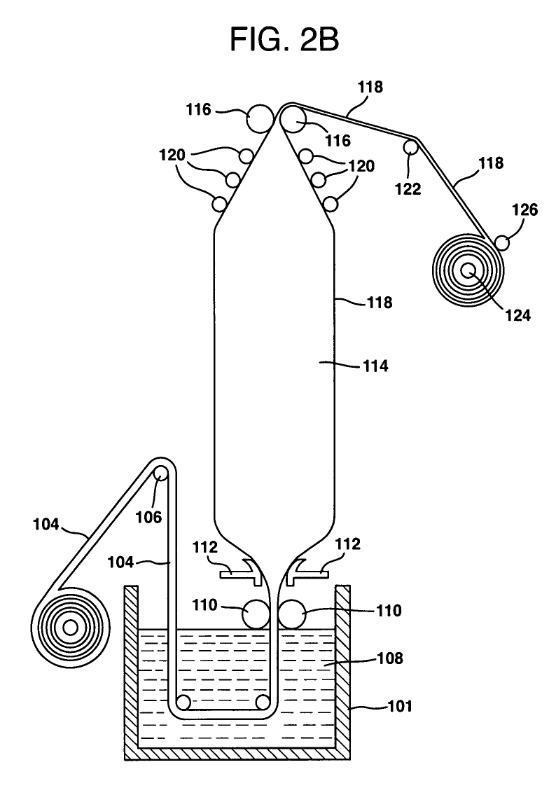

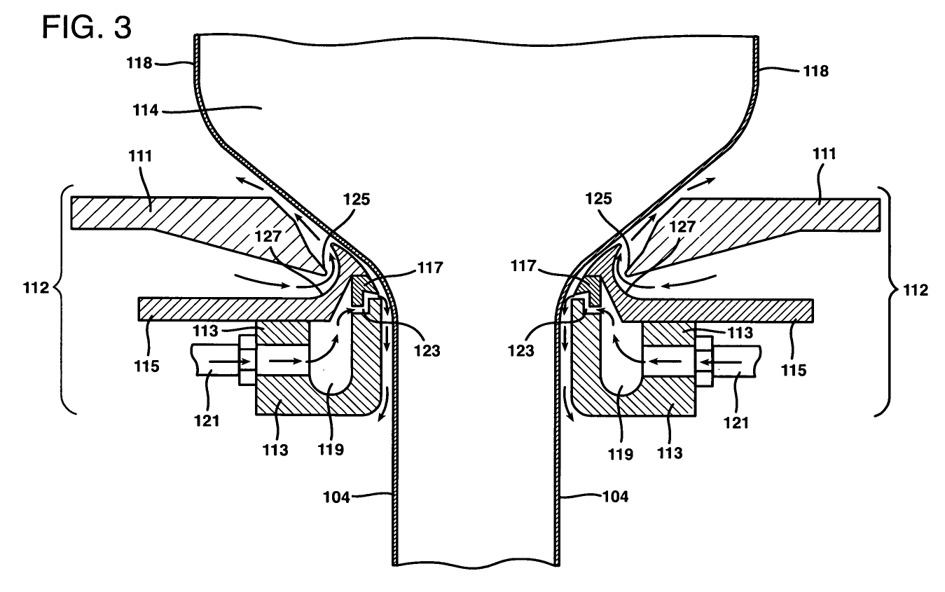

Viewing FIG. 1, FIG. 2A, FIG. 2B, FIG. 2C, and FIG. 3 together, a heat-shrinkable film is prepared by feeding solid polymer beads (not illustrated) to a plurality of extruders 52 (for simplicity, only one extruder is illustrated). Inside extruders 52, the polymer beads are forwarded, melted, and degassed, following which the resulting bubble-free melt is forwarded and extruded through annular die 56, resulting in annular extrudate 58.

Shortly after exiting die 56, annular extrudate 58 is drawn downward toward cylindrical air shoe 60. While the outside diameter of air shoe 60 can be the same size as the diameter of the orifice of annular die 56 as illustrated in FIG. 1 and FIG. 2C, the annular extrudate 58 can be allowed to draw down (i.e., while it remains molten, extrudate 58 can undergo diameter reduction, also referred to as “necking-in”) if the outside diameter of air shoe 60 is smaller than the orifice of annular die 56. The extent of neck-in of annular extrudate 58 is limited by the outside diameter of air shoe 60, as illustrated in FIG. 2A. The necking-in of annular extrudate 58 is increased by drawing extrudate 58 downward at a speed greater than the speed at which the molten polymer emerges from annular die 56. The downward drawing of annular extrudate 58 generates tension, and results in a more stable process. This increase in process stability produces greater width uniformity in the annular extrudate 58, greater thickness uniformity in the annular extrudate 58, and improved downstream processability as the various processing operations are carried out on a more uniform annular extrudate 58. Moreover, this greater uniformity in annular extrudate 58 results in more uniform product characteristics, such as more uniform impact strength, more uniform shrink, more uniform optics, etc. Annular extrudate 58 can neck down so that its inside diameter (i.e., upon being quenched) decreases by at least 10%, at least 20%, at least 30%, at least 40%, or even at least 50% compared with its diameter at the point at which it emerges from annular die 56.

Alternatively, the extrudate can be supported in a manner so that the extrudate is prevented from necking-in as it emerges from the die, as illustrated in FIG. 1 and in FIG. 2C. In the process illustrated in FIGS. 1 and 2C, air shoe 60 is positioned over hollow pipe 62 that passes through die 56 and the hollow center of air shoe 60. Air shoe 60 has an outside diameter large enough that annular extrudate 58 is supported and is prevented from substantially necking-in upon emergence from annular die 56. The outer surface of air shoe 60 is roughened with 80-grit sandpaper. Integral with air shoe 60 is upper flange 64 thereof, which is bolted to the bottom surface of die 56.

In use, pressurized air line 68 supplies cooled, pressurized air to an interior chamber within air shoe 60. The air supplied to air shoe 60 can have a temperature of from 45° F. to 80° F., and preferably has a temperature of about 60° F. The pressurized air supplied to air shoe 60 from air line 68 initially flows into the interior chamber within air shoe 60, and thereafter flows radially outward through a plurality of holes 76 toward the inside surface 86 of annular extrudate 58. Holes 76 preferably have a diameter of about 0.030 inch, and are preferably spaced uniformly over the surface of air shoe 60, with each hole 76 being about 0.563 inch from its nearest neighbor, in a pattern so that each hole 76 is surrounded by a maximum of 6 additional holes 76.

Shortly after the emergence of annular extrudate 58 from die 56, downward-moving annular extrudate 58 is rapidly quenched by contact with an annular stream 80 of cool water emitted from annular water ring 78. Annular stream 80 contacts outside surface 88 of annular extrudate 58, with annular stream 80 traveling downward on the exterior surface of annular extrudate 58 as cascading water 82. Annular stream 80 contacts outside surface 88 of annular extrudate 58 within a distance of from 0.1 inch to 8 inches downstream of the annular die; or within a distance of from 0.5 inch to 5 inches; or within a distance of from 0.5 to 3 inches, or within a distance of from 1 to 3 inches.

Annular stream 80 of cool water, which becomes cascading cool water 82, quickly draws heat from annular extrudate 58, and thereby quickly quenches (i.e., solidifies) the polymers making up annular extrudate 58. In fact, annular stream 80 and cascading water 82 draw heat from annular extrudate 58 so quickly that the semi-crystalline polyamide within annular extrudate 58 solidifies before it has an opportunity to undergo substantial crystallization. It has been discovered that the quenching is carried out so rapidly that the semi-crystalline polyamide in annular extrudate 58 is frozen in a state in which it is more readily oriented to make a heat-shrinkable film.

Although annular stream 80 and cascading water 82 are the primary sources for the rapid quenching of annular extrudate 58, the cool air emitted from air shoe 60 also serves to quench annular extrudate 58 from the inside out. However, the primary purpose of the air emitted from air shoe 60 is to provide a slightly superatmospheric pressure within annular extrudate 58, in order to prevent the collapse of annular extrudate 58 as it is contacted by annular stream 80 of cool water which becomes cascading water 82. The cool air emitted from holes 76 in air shoe 60 emerges from air shoe 60 into narrow gap 90 between the outside surface 84 of air shoe 60 and the interior surface 86 of annular extrudate 58. Gap 90 is typically only from about 0.001 to about 0.5 inch wide, more commonly from about 0.001 to about 0.05 inch wide. The flow of cool air emitted from holes 76 is downward toward and into open end 92 of hollow pipe 62. The cool air then travels upward through hollow pipe 62 and through the open center of die 56, with the cool air being evacuated into the environment.

Annular extrudate 58 and cascading water 82 both travel downward towards nip rollers 92. Cascading water 82 flows into catch basin 91, and is thereafter recycled through pump and cooling means 89, with the recooled water being recirculated to annular water ring 56.

As annular extrudate 58 passes through nip rollers 93, annular extrudate 58 is reconfigured from an inflated configuration to a lay-flat configuration. The resulting reconfigured lay-flat annular extrudate 94 is thereafter wound up on a reel (not illustrated). Optionally, lay-flat annular extrudate 94 can be fed through irradiation vault 96 surrounded by shielding 98, where annular extrudate 94 is irradiated with high energy electrons (i.e., ionizing radiation) from iron core transformer accelerator 100. Annular extrudate 94 can be guided through irradiation vault 96 on a series of rollers 102. Preferably, the irradiation of lay-flat annular extrudate 94 is at a level of from about 2 to 10 megarads (hereinafter “MR”), after which lay-flat annular extrudate 94 is wound up on reel 95 as irradiated lay-flat annular extrudate 104.

As a second step of the process, the wound up, irradiated, lay-flat annular extrudate 104 is unwound and directed over guide roller 106, after which irradiated annular extrudate 104 is passed into and through hot water 108 in tub 110 containing hot water 108. While the temperature of hot water 108 can be from about 125° F. to about 212° F., or from 130° F. to 210° F., or from 135° F. to 180° F., hot water 108 is preferably maintained at a temperature of about 175° F. Annular extrudate 104 is forwarded into and through hot water 108 so that it remains immersed in hot water 108 for a period of from about 0.25 second to about 10 seconds, or from 0.5 to 4 seconds, or from 1 to 3 seconds. Preferably, annular extrudate 104 is immersed for a period of from about 1 to 2 seconds. It is preferred to immerse annular extrudate 104 in hot water 108 for the minimum time necessary to bring annular extrudate 104 up to the desired temperature for solid state biaxial orientation.

Upon emergence from hot water 108, annular extrudate 104 passes through lower set of nip rollers 110, and through annular air ring 112 as annular extrudate 104 is pulled upward by upper set of nip rollers 116. Annular air ring 112 is supplied with cool, compressed air at a temperature of from 45° F. to about 90° F., or from 30° F. to 120° F., or a temperature of about 60° F. The cool air is supplied to air ring 112 from a plurality of air lines, each air line providing cool air at a pressure of up to 150 psi.

Upon emergence from lower nip rollers 110, annular extrudate 104 is solid-state oriented in both the machine direction and the transverse direction as it moves upward and passes around a trapped air bubble 114, and towards upper nip rollers 116. The surface speed of upper nip rollers 116 is greater than the surface speed of lower nip rollers 110. The solid state orientation stretches annular extrudate 104 in both the machine direction and the transverse direction, resulting in the formation of biaxially-oriented, heat-shrinkable, retortable film 118.

FIG. 3 provides an enlarged, detailed, cross-sectional view of annular extrudate 104 at the point in the process at which extrudate 104 passes through air ring 112. Air ring 112 is an assembly of upper ring 111 and a lower ring which is an assembly of cap member 113 bolted to plate member 115 and air permeable insert 117. Air permeable insert 117 can be designed of sintered metal, such as sintered bronze. Another air ring capable of the performance of the sintered bronze is an air ring insert such as the microbored air ring insert available from Future Design, Inc, at 5369 Maingate Drive, Mississauga, Ontario, Canada LW4 1G6 (web address of www.saturn2.com). The sintered bronze and microbored air ring inserts are both microporous, due to the sintered metal design or due to micro bored holes therein (hole diameter within the range of from 0.002 to 0.02 inch, or from 0.005 to 0.01 inch).

Compressed air (at 20 to 150 psi) passing through porous insert 117 is supplied to chamber 119 by air lines 121. Pressurized air in chamber 119 enters passageway 123 and passes outward and down, around the outside of extrudate 104. The effect of the airstream passing downward and around extrudate 104 is to pull trapped bubble 114 of air downward, to prevent trapped bubble 114 from moving upward and bursting oriented film 118. Simultaneously, a fan supplies air to the region between plate member 115 and upper ring 111, this air passing between the inside edge 125 of upper ring 111 and the outside concave surface 127 of plate member 115. This air passes out of air ring 112 and around extrudate 104 as extrudate 104 is being oriented. The effect of this second airstream is to pass upward and around extrudate 104 to push trapped bubble 114 upward, the prevent trapped bubble 114 from moving downward and into air ring and onward toward lower nip rollers 110, which likewise would be problematic for continuation of the process. In this manner, air ring 112 provides opposing airstreams to stabilize the lower position of trapped bubble 114. As can also be seen in FIG. 3, as extrudate 104 is oriented to produce heat-shrinkable, retortable film 118, it thins down from the thickness of the tape to the final film thickness.

As a result of the transverse stretching and longitudinal drawing of annular extrudate 104, irradiated, biaxially-oriented, heat-shrinkable retortable film 118 is produced. Heat-shrinkable, retortable film 118 has been drawn in the longitudinal direction in the solid state, and stretched in the transverse direction in the solid state, in at a total orientation ratio (i.e., L+T) of from about 1:2 to about 1:20, or from 1:2.5 to 1:16, or from 1:4 to 1:14, or about 1:9. The result is a biaxial oriented, heat-shrinkable retortable film.

As annular, heat-shrinkable, retortable film 118 approaches upper nip rollers 116, it is collapsed into lay-flat configuration by rollers 120, thereafter passing between nip rollers 116. Heat-shrinkable film 118 is then forwarded over guide roller 122, and then rolled onto wind-up roller 124. Idler roller 126 assists with wind-up. While not illustrated, annealing rollers and cooling rollers can (optionally) be provided between nip rollers 116 and wind up roller 124.

The amount of solid state orientation of annular extrudate 104, and the ease of solid state orientation of annular extrudate 104, is significantly affected by a variety of factors. It is the relatively high proportion of semi-crystalline polyamide in the annular extrudate that makes the annular extrudate difficult to orient in the solid state. However, the process described above provides several features that significantly improve the ability to orient such an annular extrudate. The first factor is the rapid quenching of the annular extrudate as it emerges from the die. A second factor is the relatively low temperature of hot water 108. A third factor is the relatively low immersion time of annular extrudate 104 in hot water 108. A fourth factor is the relatively rapid cooling of the heated annular extrudate 104 by air ring 112 upon emergence of annular extrudate 104 from hot water 108. The rapid quenching, the reheating to a relatively low temperature for a relatively short time and the rapid cooling upon emergence from the water bath all assist in enhancing the amount of solid state orientation, and the ease of the solid state orientation. They also assist in lowering the temperature at which the solid state orientation occurs. Lowering the temperature at which the solid state orientation occurs produces a film that is heat-shrinkable at a lower temperature. A lower shrink temperature is advantageous for the packaging of heat-sensitive products, because less heat is required to shrink the film tight against the product, thereby providing an attractive tight package appearance while exposing the heat-sensitive product to less heat during the heat shrinking of the film tight around the product.

It is believed that each of the four factors impair the crystallization of the semi-crystalline polyamide, which makes the extrudate easier to orient in the solid state. It has been found that this process also produces a heat-shrinkable, retortable film having a high total free shrink at 185° F. together with low haze and high clarity, in spite of the presence of a relatively high proportion of semi-crystalline polyamide in the resulting heat-shrinkable, retortable film 116.

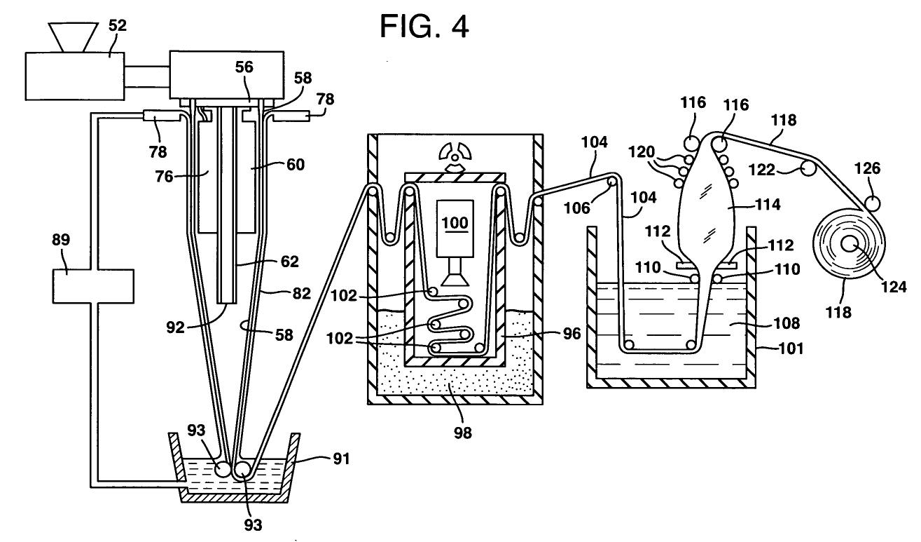

FIG. 4 illustrates a one-step process for making the heat-shrinkable, retortable film. In the process of FIG. 4, all equipment and steps are the same as the two-step process of FIG. 1, except that the annular extrudate 104 is not wound up after irradiation and thereafter unwound before solid state orientation. Rather, annular extrudate 104 emerges from irradiation vault 96 and is then forwarded directly into hot water 108. Otherwise, all of the enumerated components of the process illustrated in FIG. 4 correspond with the components described above with reference to FIGS. 1, 2, and 3. While not illustrated, annealing rollers and cooling rollers can (optionally) be provided between nip rollers 116 and wind up roller 124.

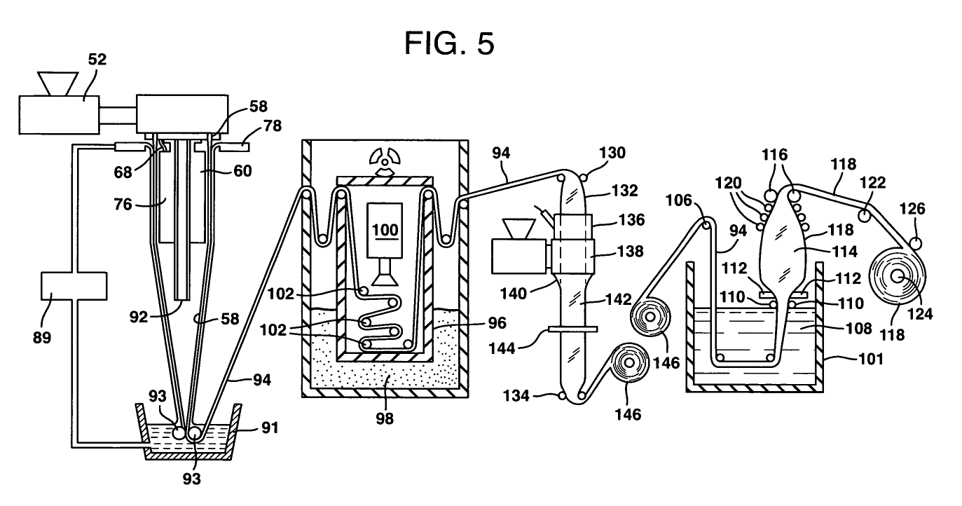

FIG. 5 illustrates a two-step process for producing an extrusion-coated, heat-shrinkable, retortable film. In the process of FIG. 5, all equipment and steps are the same as the two-step process illustrated in FIGS. 1, 2, and 3 as described above, except that annular extrudate 58 serves as a substrate onto which one or more additional layers are extrusion coated with a coating of one or more film layers.

More particularly, after the optional irradiation of annular extrudate 58 (i.e., annular substrate 58), annular irradiated extrudate 94 (i.e., annular irradiated substrate 94) is directed to nip rollers 130 while in lay-flat configuration. Immediately downstream of nip rollers 130, annular irradiated substrate 94 is reconfigured from lay-flat configuration to round configuration by being directed around trapped air bubble 132 which extends from nip rollers 130 to nip rollers 134. The resulting round annular substrate 94 is then directed through vacuum chamber 136, immediately following which round annular substrate 94 is passed through extrusion coating die 138, which extrudes coating stream 140 over and around the outside surface of round annular substrate 94, resulting in round extrusion coated extrudate 142, which is then passed through and cooled by a second water ring 144 and thereafter forwarded through nip rollers 134 at which time round extrusion coated extrudate 142 is reconfigured into lay-flat configuration and wound up on roll 146. Second water ring 144 can be positioned from about 1 to 6 inches downstream of extrusion coating die 138, or from about 2 to 5 inches downstream of die 138. A stream of cool water (e.g., at 7.2° C., not illustrated) is emitted from second water ring 144, with this stream of cool water flowing onto the exterior surface of extrusion-coated tape 142, in order to rapidly quench the hot coating layers, particularly to retard crystallization of any semi-crystalline polyamide present in either the coating layers or the substrate layers.

Annular extrudate 94 is not significantly drawn (either longitudinally or transversely) as it is directed around trapped air bubble 132. The surface speed of downstream nip rollers 134 is about the same as the surface speed of upstream nip rollers 130. Furthermore, annular extrudate 94 is inflated only enough to provide a substantially circular tubing without significant transverse orientation, i.e., without transverse stretching. Further details of the above-described coating step are generally as set forth in U.S. Pat. No. 4,278,738, to BRAX et. al., which is hereby incorporated by reference thereto, in its entirety. Otherwise, all of the enumerated components of the process illustrated in FIG. 5 correspond with the components described above with reference to FIGS. 1, 2, and 3.

In the second step of the two-step process of FIG. 5, roll 146 is transported to a location for solid-state orientation, and is there unwound so that irradiated extrudate 94 passes into hot water 108 and is thereafter biaxially oriented in the same manner as illustrated in FIGS. 1, 2A, 2B, and 3, described above. While not illustrated, annealing rollers and cooling rollers can (optionally) be provided between nip rollers 116 and wind up roller 124.

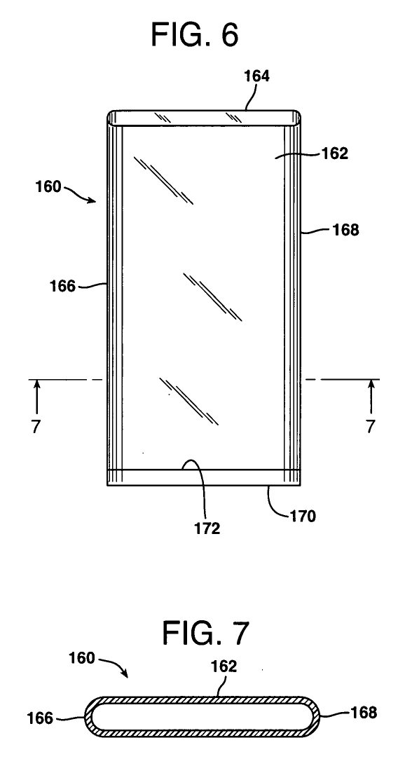

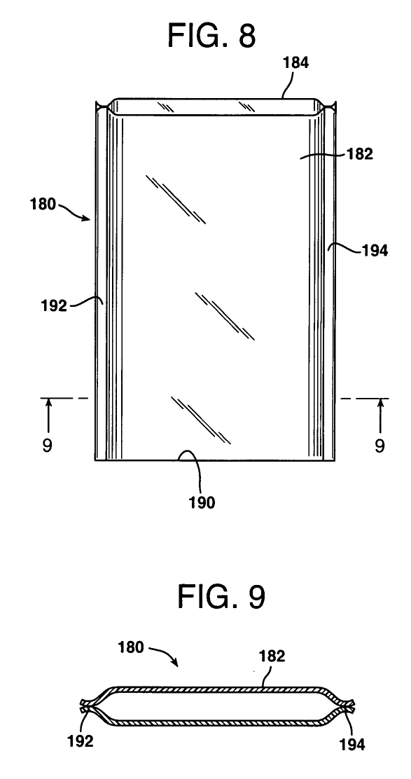

FIG. 6 is a schematic of a retortable, heat-shrinkable end-seal bag 160 in lay-flat configuration. End-seal bag 160 is made from the heat-shrinkable, retortable film. FIG. 8 is a cross-sectional view of bag 160 taken through section 8-8 of FIG. 7. Viewing FIGS. 6 and 7 together, bag 160 comprises bag film 162, top edge 164 defining an open top, first bag side edge 166, second bag side edge 168, bottom edge 170, and end seal 172.

FIGS. 8 and 9 together illustrate retortable, heat-shrinkable side-seal bag 180 in lay-flat configuration. Side-seal bag 180 is made from the heat-shrinkable, retortable film. FIG. 9 is a cross-sectional view of bag 180 taken through section 10-10 of FIG. 8. Viewing FIGS. 8 and 9 together, side-seal bag 180 is made from bag film 182 which is heat sealed to itself. Side seal bag 180 has top edge 184 defining an open top, bottom edge 190, first side seal 192, and second side seal 194.

Although not illustrated, a retortable, heat-shrinkable pouch can be made from two separate pieces of film. Unlike the end-seal and side-seal bags described above, the pouch is made by heat sealing two separate pieces of film together, with the pouch having an open top, a first side seal, a second side seal, and a bottom seal.

A heat-shrinkable retortable film is best used for the packaging of non-flowable products, such as whole muscle meat cuts (pork, beef, poultry, etc.) It can be particularly advantageous to package meat products that produce a high amount of purge during the retort cycle. This purge is undesirable because a loss of product when the product is opened and poor visual appearance. A shrinkable product may minimize this purge and have an aesthetically desirable tight appearance. For example, it may be desirable to package processed meat products and pet food products in a heat-shrinkable, retortable film.

In all of the examples below, unless otherwise indicated, the extrudate is to be quenched (or was quenched) using a water ring that emitted a flow of water onto the extrudate, with the flow of water cascading down the extrudate. In these examples, approximately 100% of the water emitted by the water ring contacts (or contacted) the extrudate and cascades (or cascaded) down the extrudate for a distance of at least 24 inches.

### EXAMPLE 1

A coextruded multilayer heat-shrinkable retortable film is produced utilizing the apparatus and process set forth in FIG. 1, described above. The multilayer film has a total of 7 layers, in the following order, with the thickness of each layer of the tape (i.e., the extrudate prior to solid state orientation) shown in mils being indicated below the layer identity and resin composition identification:

Layer Arrangement, Composition, and Thickness of Film of Example 1

| Sealant | Tie | Core | Barrier | Core | Tie | Outer |
|---|---|---|---|---|---|---|
| High melt | Tie 1 | Nylon 1 | Barrier 1 | Nylon 1 | Tie 1 | High melt |
| point | | | | | | point |
| polymer | | | | | | polymer |
| 1.5 mils | 1 mil | 3.25 mils | 1 mil | 3.25 mils | 1 mil | 1.5 mils |

The identity of the various resins in the film of Example 1 is as follows:

| Resin code | Resin Identity |
|---|---|
| High Melting | MDPE, HDPE, PEC, PA copolymer, PP Homopolymer |
| Point Polymer | |
| Tie 1 | Anhydride grafted LLDPE, MDPE, HDPE, PP, EVA, |
| | EMA, PEC |
| Nylon 1 | Semi-crystalline Nylon, Amorphous Nylon |
| Barrier 1 | EVOH, Retortable EVOH, Amorphous Nylon, MXD6, |
| | MXD6/MXDI, and nanocomposite barrier materials |

The extrudate is cast from an annular die (diameter of 12.7 cm) over an air shoe that provides the melt with the needed support to minimize gauge band variation. The air shoe has an outside diameter of 12.7 cm and a length of 32 cm, and emits cool air (15.6° C.) through 0.762 mm diameter holes spaced over the cylindrical surface of the air shoe, the holes being spaced apart by a distance of 14.3 mm, with the holes being arranged so that each hole inside the matrix of holes were surrounded by 6 holes. The airflow through the holes supports the film (so that it does not collapse) and cooled the film from the inside out, i.e., to assist in quenching the molten extrudate quickly to minimize crystallization. The pressure between the air shoe and the film is slightly above atmospheric pressure (i.e., about 780 mm Hg). The cool air is pumped into the hollow air shoe and out the holes, with the air then flowing down beneath the air shoe and then up out through a passageway through the center of the air shoe.

Although the air shoe assists in freezing the nylon to minimize crystal formation, most of the heat in the extrudate is removed using a water ring positioned approximately 2 inches below the annular die. The water ring emits a stream of cool water (e.g., at 7.2° C.) against the outer surface of the extrudate to produce sudden freezing of the extrudate to minimize crystallization in the nylon layers. The stream of cool water contacts the extrudate at a distance of about 2 inches downstream of the annular die. The resulting quenched tape is collapsed into lay-flat configuration and wound up onto a reel and transported to equipment for solid state orientation of the tape. The tape is then unwound and forwarded to a bath containing hot water, collapsed into lay-flat configuration, and heated to a temperature of 71° C. The tape remains immersed in the hot water for a period of 2 seconds, immediately following which the heated tape is forwarded through a first set of nip rollers and then through a second set of nip rollers, with the distance between the first and second sets of nip rollers being about 6 feet. Between the first and second sets of nip rollers, the tape is subjected to a solid state biaxial orientation. Orientation is produced by inflating the tape with a trapped bubble of air between the first and second sets of nip rollers. Additional orientation is provided by running the first set of nip rollers at a surface speed of 15 meters per minute, and the second set of nip rollers at a surface speed of 42 meters per minute. The result is 2.8× orientation in the transverse direction and 2.8× orientation in the machine direction, for a total biaxial orientation of 7.8.

### EXAMPLE 2

The retortable film of Example 2 is prepared in a manner similar to the preparation of the film of Example 1, described above. The film of Example 2 also has a total of 7 layers, in the following order, with the thickness of each layer of the tape (i.e., prior to solid state orientation) shown in mils being indicated below the layer identity and resin composition:

Layer Arrangement, Composition, and Thickness of Film of Example 2

| Sealant | Tie | Core | Barrier | Core | Tie | Outer |
|---|---|---|---|---|---|---|
| High melt | Tie 1 | 90% Nylon 1 + 10% | Barrier 1 | 90% Nylon 1 + 10% | Tie 1 | High |
| point | | crystallinity | | crystallinity | | melt |
| polymer | | interrupter | | interrupter | | point |
| | | | | | | polymer |
| 1.5 mils | 1 mil | 3.25 mils | 1 mil | 3.25 mils | 1 mil | 1.5 mils |

The identity of the various resins in the film of Example 2 is the same as in the table above in Example 1. The only additional resin, i.e., the crystallinity interrupter, comprises at least one member selected from the group consisting of: polyamide 6/12, polyamide 6/69, polyamide 6I/6T, polyamide MXD6, polyamide MXDI, polyamide 66/610, amorphous polyamide, polyether block amide copolymer, polyester (including polyethylene terephthalate/glycol), EVOH, polystyrene, polyolefin (e.g., polybutene, long chain branched homogeneous ethylene/alpha-olefin copolymer, and linear low density polyethylene), and ionomer resin. The crystallinity interrupter is blended with the Nylon 1. The semi-crystalline polyamide is the primary component present in the blend with the crystallinity interrupter. The primary component makes up from 60 to 99 weight percent of the blend and the secondary component making up from 1 to 40 weight percent of the blend. Any heat-shrinkable, retortable film of the invention can comprise a blend of the semi-crystalline polyamide with a crystallinity interrupter as set forth above.

The annular die, air shoe, cooling air, water ring, cooling water, hot bath, immersion time, air ring, etc., and conditions, are all carried out as set forth in Example 1, above.

### EXAMPLE 3

The retortable film of Example 3 is prepared in a manner similar to the preparation of the film of Example 1, described above. However, the film of Example 3 is prepared by an extrusion coating process as illustrated in FIG. 5, described above. As shown in the table below, the film of Example 3 has a total of 8 layers, with the first 4 layers being coextruded from an annular die as a substrate, and the fifth through eighth layers being extrusion-coated onto the substrate, these last four layers being referred to as the coating layers. The semi-crystalline nylon is present in one of the substrate layers. As in Example 1 and Example 2, the extruded substrate portion of the film is rapidly quenched upon emerging from the die. The rapid quench is accomplished primarily by placing the water ring close to the die so that a cascade of cool water contacts the annular extrudate immediately upon emergence of the extrudate from the die. While the various layers of the substrate may be irradiated, the coating layers are not irradiated. The coating layers provide the film with a high barrier to atmospheric oxygen (and other materials), add abuse resistance, and enhance the subsequent processability (i.e., orientability) of the multilayer extrudate.

Layer Arrangement, Composition, and Thickness of Film of Example 3

| substrate | substrate | substrate | Substrate | coating | coating | coating | coating |
|---|---|---|---|---|---|---|---|
| Sealant | Tie | Core | Tie | Barrier | Tie | Core | Outer |
| High melt | Tie 2 | Nylon 1 | Tie 2 | Barrier 1 | Tie 3 | Bulk 1 | High melt |
| point | | | | | | | point |
| polymer | | | | | | | polymer |
| 3 mils | 1 mil | 12 mils | 1 mil | 2 mils | 1 mil | 2 mils | 1 mil |

The annular die used in the process has a diameter of 5 inches, and the air shoe has a diameter of 4.25 inches and a length of 13 inches. The diameter of the coating die is 3.5 inches. Otherwise, the process used to produce the film of Example 3 is as described in Example 1, above, including the cooling air, water ring, cooling water, hot bath, immersion time, and annealing apparatus and conditions. The identity of the various resins in the film of Example 3 are as follows:

| Resin code | Resin Identity |
|---|---|
| High Melting | MDPE, HDPE, PEC, PA copolymer, PP homopolymer |
| Point Polymer | |
| Tie 2 | Anhydride grafted LLDPE, MDPE, HDPE, PP, EVA, |
| | EMA, PEC |
| Tie 3 | EVA, EMA |
| Nylon 1 | Semi-crystalline Nylon, Amorphous Nylon |
| Interrupter 1 | polyamide 6/69, polyamide 6I/6T, polyamide MXD6, |
| | polyamide MXDI, polyamide 66/610, amorphous |
| | polyamide, polyether block amide copolymer, polyester |
| | (including polyethylene terephthalate/glycol), EVOH, |
| | polystyrene, polyolefin (e.g., polybutene, long chain |
| | branched homogeneous ethylene/alpha-olefin |
| | copolymer, and linear low density polyethylene), |
| | and ionomer resin. |
| Bulk 1 | Polyolefin |
| Barrier 1 | EVOH, Retortable EVOH, Amorphous Nylon, MXD6, |
| | MXD6/MXDI, and nanocomposite barrier materials |

The resulting extrusion-coated tape is wound up onto a reel, transported to a location for solid state orientation, and then unwound and biaxially oriented in substantially the same manner described in Example 1. The resulting retortable, heat-shrinkable multilayer film is then annealed substantially as described in Example 1.

### EXAMPLE 4

The retortable film of Example 4 is prepared using an extrusion-coating process as described in Example 3, above. As shown in the table below, the film of Example 4 also has a total of 8 layers, with the first 4 layers being the substrate layers, and the fifth through eighth layers being the coating layers.

Layer Arrangement, Composition, and Thickness of Film of Example 4

| substrate | substrate | Substrate | Substrate | coating | coating | coating | coating |
|---|---|---|---|---|---|---|---|
| Sealant | Tie | Core | Tie | Barrier | Tie | Core | Outer |
| High melt | Tie 2 | Nylon 1 + crystalline | Tie 2 | Barrier 1 | Tie 3 | Bulk 1 | High |
| point | | interrupter | | | | | melt |
| polymer | | | | | | | point |
| | | | | | | | polymer |
| 3 mils | 1 mil | 12 mils | 1 mil | 2 mils | 1 mil | 2 mils | 1 mil |

The annular die, air shoe, cooling air, water ring, cooling water, hot bath, immersion time, and annealing apparatus and conditions were all carried out asset forth in Example 3, above. The identity of the various resins in the film of Example 4 is the same as in the table above in Example 3. The only additional resin, i.e., the semi-crystalline interrupter, is the same as the semi-crystalline interrupter in Example 2, above. Otherwise, the process used to produce the film of Example 4 is as described in Example 3, above.

### EXAMPLE 5

A coextruded multilayer heat-shrinkable retortable film was produced utilizing the apparatus and process set forth in FIGS. 1, 2, and 3, described above. The multilayer film had a total of 7 layers, in the following order, with the thickness of each layer of the tape (i.e., prior to solid state orientation) indicated below the layer identity and resin composition identification:

Layer Arrangement, Composition, and Thickness of Film of Example 5

| Sealant | Tie | Core | Barrier | Core | Tie | Outer |
|---|---|---|---|---|---|---|
| MDPE 1 | Tie 4 | Nylon 2 | EVOH 1 | Nylon 2 | Tie 4 | MDPE 1 |
| 1.5 mils | 1 mil | 3.25 mils | 1 mil | 3.25 mils | 1 mil | 1.5 mils |

The identity of the various resins in the film of Example 5 was as follows:

| Resin code | Resin Identity |
|---|---|
| MDPE1 | Dow Dowlex ® 2037 0.935 D |
| Tie 4 | Equistar Plexar ® PX3227 |
| Nylon 2 | BASF Ultramid ® B40 |
| EVOH 1 | EVAL LC-E105A |

The 7-layer extrudate (i.e., tape) was coextruded (i.e., downward cast) from an annular die (diameter of 5 inches) over an air shoe that provided the emerging melt stream with the needed support to minimize gauge band variation in the resulting tape. The air shoe had an outside diameter of 4.25 inches and a length of 13 inches, and emitted cool air (15.6° C.) through 0.030 inch diameter holes spaced over the outer cylindrical surface of the air shoe, the holes being spaced apart by a distance of 0.5625 inch, with the holes being arranged so that each hole inside the matrix of holes were surrounded by 6 holes. The airflow through the holes supported the film (so that it did not collapse due to impingement of a flow of cool water thereon, as described below) and cooled the film from the inside out, i.e., to assist in “freezing” the nylon quickly to minimize crystallization of the nylon. The pressure between the air shoe and the inside surface of the tape was slightly above atmospheric pressure (i.e., about 1.03 atmosphere). The cool air was pumped into the hollow air shoe and out the small holes terminating the passageways leading from the internal chamber within the air shoe to the outer surface thereof. The cool air flowed downward in the small gap (about 0.005 inch) between the tape and the outer surface of the air shoe, the cool air then passing into and upwardly through the centrally located pipe, after which the air passed out of the upper end of the pipe and into the environment.

Although the air shoe assisted in freezing the polyamide to minimize crystallization thereof, most of the heat in the extrudate emerging from the die was removed by a stream of cool water emitted from a water ring positioned approximately 2 inches downstream of the annular die. The water ring emitted a stream of cool water (about 7.2° C.) against the outer surface of the extrudate to produce sudden freezing (i.e., quenching) of the polymers in the various film layers. The sudden quenching was employed particularly for the purpose of quickly quenching (and thereby minimize the crystallization) of the semi-crystalline polyamide in each of the two core layers identified in the table above. The water ring was sized so that its inside surface was from 1-2 inches from the extrudate. The water ring was positioned so that the annular stream of cool water it emitted contacted the extrudate about 2 inches downstream of the point at which the extrudate emerged from the annular die. The water was emitted from the water ring as a stream in an initially horizontal direction, with the stream arcing downward slightly before making contact with the extrudate. This very rapid quenching process, coupled with a minimization of dwell time in a hot water bath before orientation and the relatively low temperature of the hot bath (described below), the positioning and emission of the cool air from an air ring (also described below), all assist in orienting the extrudate in a manner resulting in the heat-shrinkability, and other properties, set forth below.

Beneath the die, the quenched tape was collapsed into lay-flat configuration and wound up onto a reel. The reel of quenched tape in lay-flat configuration was then transported to a location for solid-state orientation. The tape was then unwound and forwarded to a bath containing hot water at a temperature of 71° C. The tape was continuously forwarded through the bath with a residence time of about 2 seconds of immersion in the hot water, following which the resulting heated tape was immediately forwarded through a first set of nip rollers followed by a second set of nip rollers, with the distance between the first and second sets of nip rollers being about 6 feet. The tape was biaxially-oriented between the upper and lower sets of nip rollers by passing the tape around a trapped bubble of air. Biaxial orientation was produced by both (a) inflating the tape with the trapped bubble of air between the sets of nip rollers, and (b) running the first set of nip rollers at a surface speed of 15 meters per minute, and running the second set of nip rollers at a surface speed of 42 meters per minute. The result was about 2.8× orientation in the transverse direction and about 2.8× orientation in the machine direction, for a total biaxial orientation of about 7.8×. The resulting retortable, annular, heat-shrinkable, coextruded film was not annealed.

The resulting retortable, heat-shrinkable, coextruded film exhibited a high total free shrink at 185° F., a high abrasion resistance, a high puncture strength, and was able to withstand retort conditions of 250° F. for 90 minutes. At this condition a total shrink of 51% was experienced. The table below provides the gauge and free shrink of the retortable, heat-shrinkable film of Example 5.

| Film of | Film Gauge | % free shrink at |
|---|---|---|
| Example No. | (mils) | 185° F. (L + T) |
| 5 | 2.1 | 26 + 25 |

### EXAMPLES 6-10

Examples 6-10 were five additional heat-shrinkable, retortable films produced utilizing the apparatus and process set forth in FIGS. 1, 2, and 3, described above, i.e., as set forth in Example 5, above. Each of the films of Examples 6-10 had a total of 7 layers, in the following order, with the percent thickness of each layer of the tape and film being indicated at the bottom of the layer composition description.

Layer Arrangement, Composition, and Thickness of Films of Examples 6-10

| | | Tie | | | | Tie | |
|---|---|---|---|---|---|---|---|
| | Outer layer | layer | Bulk layer | Barrier layer | Bulk layer | layer | Outer layer |
| Example 6 | MDPE 1 | Tie 4 | 90% | Amorphous | 90% | Tie 4 | MDPE 1 |
| | | | Nylon 1 | Nylon | Nylon 1 | | |
| | | | 10% | | 10% | | |
| | | | Amorphous | | Amorphous | | |
| | | | Nylon | | Nylon | | |
| % of | 12 | 8 | 26 | 8 | 26 | 8 | 12 |
| film | | | | | | | |
| Example 7 | 65% | Tie 4 | 90% | Amorphous | 90% | Tie 4 | 65% |
| | MDPE | | Nylon 1 | Nylon | Nylon 1 | | MDPE |
| | 30% HDPE | | 10% | | 10% | | 30% HDPE |
| | 5% Slip 1 | | Amorphous | | Amorphous | | 5% slip |
| | | | Nylon | | Nylon | | |
| % of | 12 | 8 | 26 | 8 | 26 | 8 | 12 |
| film | | | | | | | |
| Example 8 | LLDPE 1 | Tie 4 | 90% | Amorphous | 90% | Tie 4 | LLDPE 1 |
| | | | Nylon 1 | Nylon | Nylon 1 | | |
| | | | 10% | | 10% | | |
| | | | Amorphous | | Amorphous | | |
| | | | Nylon | | Nylon | | |
| % of | 12 | 8 | 26 | 8 | 26 | 8 | 12 |
| film | | | | | | | |
| Example 9 | P-E Cop | Tie 4 | 90% | Amorphous | 90% | Tie 4 | P-E Cop |
| | | | Nylon 1 | Nylon | Nylon 1 | | |
| | | | 10% | | 10% | | |
| | | | Amorphous | | Amorphous | | |
| | | | Nylon | | Nylon | | |
| % of | 12 | 8 | 26 | 8 | 26 | 8 | 12 |
| film | | | | | | | |
| Example | 50% P-E | Tie 4 | 90% | Amorphous | 90% | Tie 4 | 50% P-E |
| 10 | Copolymer | | Nylon 1 | Nylon | Nylon 1 | | Copolymer |
| | 44% homo | | 10% | | 10% | | 44% sscat |
| | VLDPE | | Amorphous | | Amorphous | | VLD |
| | 6% slip & | | Nylon | | Nylon | | 6% slip & |
| | antiblock | | | | | | antiblock |
| % of | 12 | 8 | 26 | 8 | 26 | 8 | 12 |
| film | | | | | | | |

The identity of the various resins in the films of Examples 6-10 are set forth in the table below. Resin codes set fourth in the table above, but not identified in the resin identity table below, are as set forth in the resin identity table in Example 5.

| Resin code | Resin Identity |
|---|---|
| Amorphous Nylon | Selar ® PA 3426 amorphous nylon 1.19 g/cc (DuPont) |
| HDPE | Fortiflex ® T60-500-119 high density polyethylene; 0.961 g/cc, |
| | 6.0 g/10 min (Ineos) |
| Slip 1 | 10850 antiblock and slip in LLDPE; 0.95 g/cc; 1.8 g/10 min |
| | (Ampacet) |
| LLDPE 1 | Dowlex ® 2045.03 linear low density polyethylene; 0.92 g/cc, 1.1 g/ |
| | 10 min (Dow) |
| P-E Copolymer | ED 01-03 propylene-ethylene copolymer; 0.90 g/cc; 8 g/10 min; |
| | 134° C. mp (Total Petrochemicals) |
| Homo VLDPE | Single site catalyzed Exact ® 3128 ethylene/butene copolymer; |
| | 0.900 g/cc; 1.3 g/10 min (ExxonMobil) |
| Slip & Antiblock | 102804 antiblock and slip in HDPE; 1.02 g/cc, 7.1 g/10 min |
| | (Ampacet) |

The table below provides the gauge and free shrink for the retortable films of Examples 6-10.

| | Film | % free shrink at |
|---|---|---|
| Film of | Gauge | 185° F. |
| Example No. | (mils) | (L + T) |
| 6 | 2.9 | 27 + 37 |
| 7 | 2.7 | 28 + 32 |
| 8 | 3.4 | 35 + 43 |
| 9 | 2.8 | 20 + 27 |
| 10 | 2.9 | 20 + 24 |

### EXAMPLE 11

An extrusion-coated, heat-shrinkable retortable film was produced utilizing the apparatus and process set forth in FIG. 5, described above. The film had a total of 8 layers, in the following order, with the thickness of each layer of the tape (i.e., prior to solid state orientation) indicated below the layer identity and resin composition identification:

Layer Arrangement, Composition, and Thickness of Film of Example 11

| substrate | substrate | substrate | substrate | coating | coating | coating | coating |
|---|---|---|---|---|---|---|---|
| Sealant | Tie | Core | Tie | Barrier | Tie | Core | Outer |
| MDPE 2 | Tie 5 | Nylon 2 | Tie 5 | PVDC | Tie 6 | Bulk 1 | MDPE 2 |
| 3 mils | 1 mil | 12 mils | 1 mil | 2 mil | 1 mil | 2 mils | 1 mil |

The identity of the various resins in the film of Example 11 was as follows:

| Resin code | Resin Identity |
|---|---|
| MDPE 2 | Dow Dowlex ® 2035 0.937 D |
| Tie 5 | Equistar Plexar ® PX1007 |
| Nylon 2 | BASF Ultramid ® B40 |
| Tie 6 | ExxonMobil Escorene ® LD761.36 |
| Bulk 1 | Exxon Mobile Exceed ® 1012 |
| PVDC | Dow Saran ® 806 |

The four-layer substrate extrudate was extruded (i.e., downward cast) from an annular die (diameter of 5 inches) over an air shoe that provided the emerging melt stream with the needed support to minimize gauge band variation in the resulting tape. The air shoe had an outside diameter of 4.25 inches and a length of 13 inches, and emitted cool air (15.6° C.) through 0.030 inch diameter holes spaced over the outer cylindrical surface of the air shoe, the holes being spaced apart by a distance of 0.563 inch, with the holes being arranged so that each hole inside the matrix of holes were surrounded by 6 holes. The airflow through the holes supported the film (so that it did not collapse due to impingement of a flow of cool water thereon, as described below) and cooled the film from the inside out, i.e., to assist in “freezing” the semi-crystalline polyamide quickly to minimize crystallization of the semi-crystalline polyamide. The pressure between the air shoe and the inside surface of the tape was slightly above atmospheric pressure (i.e., about 1.03 atmosphere). The cool air was pumped into the hollow air shoe and out the small holes terminating the passageways leading from the internal chamber within the air shoe to the outer surface thereof. The cool air flowed downward in the small gap (about 0.005 inch) between the tape and the outer surface of the air shoe, the cool air then passing into and upwardly through the centrally-located pipe, after which the air passed out of the upper end of the pipe and into the environment.

Although the air shoe assisted in freezing the semi-crystalline polyamide to minimize crystallization thereof, most of the heat in the extrudate emerging from the die was removed by a stream of cool water emitted from a water ring positioned approximately 2 inches downstream of the annular die. The water ring emitted a stream of cool water (about 7.2° C.) against the outer surface of the extrudate to produce sudden freezing (i.e., quenching) of the polymers in the various film layers. The sudden quenching was employed particularly for the purpose of quickly quenching (and thereby minimize the crystallization) the semi-crystalline polyamide in the core layer of the substrate, i.e., the core layer identified in the table above. The cool water contacted the extrudate at a distance of approximately 2 inches downstream of the annular die. This very rapid quenching process, coupled with a minimization of dwell time in a downstream hot water bath (described below), the positioning and emission of the cool air from an air ring (also described below), all assist in orienting the extrudate in a manner resulting in the heat-shrinkablility, and other properties, set forth below.

Beneath the die, the quenched substrate tape was collapsed into lay-flat configuration. The resulting irradiated annular tape, in lay-flat configuration, was directed through two sets of nip rollers having a trapped bubble of air therebetween, with the annular tape being reconfigured from lay-flat configuration to round configuration by being directed around the trapped bubble of air. See FIG. 5. The resulting round annular substrate was then directed through a vacuum chamber, immediately following which the round annular substrate was passed through an extrusion-coating die, which extruded a 4-layer coating stream onto and around the outside surface of the reconfigured annular substrate. The resulting 8-layer extrusion-coated tape was then forwarded through and cooled by an air ring, and then reconfigured back to lay-flat configuration by being forwarded through the second of the pairs of nip rollers, with the extrusion-coated tape then being wound up on a roll. Again, see FIG. 5.

The substrate tape was not significantly drawn (either longitudinally or transversely) as it was directed around the trapped bubble of air associated with the extrusion coating apparatus. The surface speed of the nip rollers downstream of the trapped bubble was about the same as the surface speed of the nip rollers upstream of the trapped bubble. Furthermore, the annular substrate tape was inflated only enough to provide a substantially circular tubing without significant transverse orientation, i.e., without transverse stretching. The extrusion coating was carried out in a manner in accordance with U.S. Pat. No. 4,278,738, to BRAX et. al., referred to above.

The roll of 8-layer, annular, extrusion-coated tape was transported to a location for solid-state orientation. The tape was then unwound and forwarded to a bath containing hot water at a temperature of 71° C. The tape was continuously forwarded through the bath with a residence time of about 2 seconds of immersion in the hot water, following which the resulting heated tape was immediately forwarded through a first set of nip rollers followed by a second set of nip rollers, with the distance between the first and second sets of nip rollers being about 6 feet. The tape was biaxially-oriented between the upper and lower sets of nip rollers by passing the tape around a trapped bubble of air. Biaxial orientation was produced by both (a) inflating the tape with the trapped bubble of air between the sets of nip rollers, and (b) running the first set of nip rollers at a surface speed of 15 meters per minute, and running the second set of nip rollers at a surface speed of 38 meters per minute. The result was about 2.5× orientation in the transverse direction and about 2.5× orientation in the machine direction, for a total biaxial orientation of about 6.25×. The resulting retortable, heat-shrinkable, extrusion-coated film exhibited a high total free shrink at 185° F., a high abrasion resistance, and a high puncture strength, and was able to withstand retort conditions of 250° F. for 90 minutes.

What is claimed is:

1. A retortable packaging article suitable for packaging a food product to be subject to retort conditions, comprising a multilayer heat-shrinkable film comprising:
(A) a first layer that is a first outer film layer and that serves as an inside layer of the packaging article, as a food contact layer, and as a seal layer, the first layer comprising at least one member selected from the group consisting of (i) a polyolefin having a melting point of at least 241° F., and (ii) a polyamide homopolymer or polyamide copolymer having a melting point of from 275° F. to 428° F.,
(B) a second layer that is an inner film layer and that comprises at least one semi-crystalline polyamide selected from the group consisting of:
(i) polyamide 6,
(ii) polyamide 66, and
(iii) polyamide 6/66,
wherein the at least one semi-crystalline polyamide makes up at least 65 weight percent of the second layer;
(C) a third layer that is a second outer layer and that serves as an outside layer of the packaging article, the third layer comprising at least one member selected from the group consisting of (i) a polyolefin having a melting point of at least 241° F., and (ii) a polyamide homopolymer or polyamide copolymer having a melting point of from 275° F. to 428° F.; and
wherein the multilayer film exhibits a total free shrink at 185° F. of at least 20 percent, measured in accordance with ASTM D-2732, and wherein at least one semi-crystalline polyamide selected from the group consisting of:
(i) polyamide 6,
(ii) polyamide 66, and
(iii) polyamide 6/66,
makes up at least 35 percent of the multilayer film, based on total film volume, and the first layer is heat sealed to itself.

2. The retortable packaging article according to claim 1, wherein at least one semi-crystalline polyamide selected from the group consisting of:
(i) polyamide 6,
(ii) polyamide 66, and
(iii) polyamide 6/66,
makes up at least 40 percent of the multilayer film, based on total film volume, and the multilayer film exhibits a total free shrink, at 185° F., of at least 30 percent.

3. The retortable packaging article according to claim 1, wherein at least one semi-crystalline polyamide selected from the group consisting of:
(i) polyamide 6,
(ii) polyamide 66, and
(iii) polyamide 6/66,
makes up at least 45 percent of the multilayer film, based on total film volume, and the multilayer film exhibits a total free shrink, at 185° F., of at least 40 percent.

4. The retortable packaging article according to claim 1, wherein at least one semi-crystalline polyamide selected from the group consisting of:
(i) polyamide 6,
(ii) polyamide 66, and
(iii) polyamide 6/66,
makes up at least 50 percent of the multilayer film, based on total film volume, and the multilayer film exhibits a total free shrink, at 185° F., of at least 50 percent.

5. The retortable packaging article according to claim 1, wherein the film comprises polyamide 6 in an amount that makes up at least 40 percent of the multilayer film, based on total film volume.

6. The retortable packaging article according to claim 1, wherein:
(A) the first layer comprises at least one member selected from the group consisting of medium density polyethylene, high density polyethylene, very low density polyethylene, propylene/ethylene copolymer, propylene homopolymer; and
(B) the third layer comprises at least one member selected from the group consisting of medium density polyethylene, high density polyethylene, very low density polyethylene, propylene/ethylene copolymer, and propylene homopolymer.

7. The retortable packaging article according to claim 1, further comprising a fourth layer that serves as an O₂-barrier layer, the fourth layer comprising at least one member selected from the group consisting of (i) ethylene/vinyl alcohol copolymer, (ii) polyvinylidene chloride, (iii) amorphous polyamide, and (iv) MXD6 semi-crystalline polyamide.

8. The retortable packaging article according to claim 7, further comprising a fifth layer that serves as a first tie layer, the fifth layer being between the first layer and the fourth layer, and a sixth layer that serves as a second tie layer, the sixth layer being between the third layer and the fourth layer, with the second layer being between the fifth layer and the sixth layer.

9. The retortable packaging article according to claim 8, wherein the second layer is a first polyamide layer and is between the fourth layer and the fifth layer, and the multilayer film further comprises a seventh layer that is a second polyamide layer, the seventh layer being between the fourth layer and the sixth layer, the seventh layer comprising at least one semi-crystalline polyamide selected from the group consisting of:
(i) polyamide 6,
(ii) polyamide 66, and
(iii) polyamide 6/66,
the semi-crystalline polyamide making up at least 65 weight percent of the seventh layer.

10. The retortable packaging article according to claim 1, wherein the multilayer film has a thickness of from about 1 mil to about 10 mils.

11. The retortable packaging article according to claim 1, wherein the second layer comprises a blend of a primary component with a secondary component, the primary component comprising at least one member selected from the group consisting of polyamide 6, polyamide 66, and polyamide 6/66, and the secondary component comprising at least one member selected from the group consisting of Polyamide 6/12, polyamide 6/69, polyamide 6I/6T, polyamide MXD6, polyamide MXDI, polyamide 66/610, amorphous polyamide, polyether block amide copolymer, polyester (including polyethylene terephthalate/glycol), EVOH, polystyrene, polyolefin (e.g., polybutene, long chain branched homogeneous ethylene/alpha-olefin copolymer, and linear low density polyethylene), and ionomer resin, with the semi-crystalline polyamide being different from the crystallinity interrupting component, and the semi-crystalline polyamide being present in the second layer in an amount of at least 65 weight percent, based on the weight of the second layer.

12. The retortable packaging article according to claim 11, wherein the crystallinity interrupting component is present in the second layer in an amount of from about 2 to about 35 weight percent, based on total layer weight.

13. The retortable packaging article according to claim 11, wherein the crystallinity interrupting component is present in the second layer in an amount of from about 5 to about 15 weight percent, based on total layer weight.

14. The retortable packaging article according to claim 1, wherein at least one layer of the film comprises a crosslinked polymer network.

16. The retortable packaging article according to claim 1, wherein the packaging article is a member selected from the group consisting of end-seal bag, side-seal bag, L-seal bag, pouch, seamless casing, and backseamed casing.

17. The retortable packaging article according to claim 1, wherein the multilayer film has a total free shrink at 185° F. of at least 30 percent, and the multilayer film has been annealed.

18. A process for preparing a retorted packaged product, comprising:
(A) preparing a food product;
(B) packaging the food product in a retortable packaging article made from a multilayer heat-shrinkable film comprising:
(1) a first layer that is a first outer film layer and that serves as an inside layer of the packaging article, as a food contact layer, and as a seal layer, the first layer comprising at least one member selected from the group consisting of (a) a polyolefin having a melting point of at least 241° F., and (b) a polyamide homopolymer or polyamide copolymer having a melting point of from 275° F. to 428° F.,
(2) a second layer that is an inner film layer and that comprises at least one semi-crystalline polyamide selected from the group consisting of:
(a) polyamide 6,
(b) polyamide 66, and
(c) polyamide 6/66,
wherein the at least one semi-crystalline polyamide makes up at least 65 weight percent of the second layer;
(3) a third layer that is a second outer layer and that serves as an outside layer of the packaging article, the third layer comprising at least one member selected from the group consisting of (a) a polyolefin having a melting point of at least 241° F., and (b) a polyamide homopolymer or polyamide copolymer having a melting point of from 275° F. to 428° F.; and
wherein the multilayer film exhibits a total free shrink at 185° F. of at least 20 percent, measured in accordance with ASTM D-2732, and wherein at least one semi-crystalline polyamide selected from the group consisting of polyamide 6, polyamide 66, and polyamide 6/66, makes up at least 35 percent of the multilayer film, based on total film volume, and the first layer is heat sealed to itself; and
(C) sealing the article closed so that a packaged food product is made, with the food product being surrounded by the multilayer packaging film; and
(D) retorting the food product by subjecting the packaged food product to a temperature of from 212° F. to 300° F. for a period of from 10 minutes to 3 hours.

19. The process according to claim 19, wherein the retorting is carried out by subjecting the packaged product to a temperature of from 230° F. to 270° F. for a period of at least 5 minutes.

20. The process according to claim 19, wherein the retorting is carried out by subjecting the packaged product to a temperature of from 240° F. to 260° F. for a period of from about 5 minutes to about 3 hours.
